(19) United States
(12) Patent Application Publication
(10) Pub. No.: US 2022/0230656 A1
(43) Pub. Date: Jul. 21, 2022

(54) SERVER, TERMINAL DEVICE, AND METHOD FOR ONLINE CONFERENCING

(71) Applicant: Toshiba Tec Kabushiki Kaisha, Tokyo (JP)

(72) Inventor: Naoki SEKINE, Mishima, (JP)

(73) Assignee: Toshiba Tec Kabushiki Kaisha, Tokyo (JP)

(21) Appl. No.: 17/511,389

(22) Filed: Oct. 26, 2021

(30) Foreign Application Priority Data
Jan. 18, 2021 (JP) 2021-005857

(51) Int. Cl. G10L 25/60; G10L 15/10; G10L 15/30; G10L 15/22; H04L 29/06

(52) U.S. Cl. CPC G10L 25/60; G10L 15/10; H04L 65/403; G10L 15/22; G10L 15/30

(57) ABSTRACT

A server includes a communication interface, a memory, and a processor. The communication interface communicates with a first terminal device that transmits voice data generated from an input voice and a second terminal device that outputs a voice based on the voice data received from the first terminal device. The memory stores voice recognition results by the first and second terminal devices for the input voice input to the first terminal device and the second terminal device respectively. The processor determines a difference between the input voice input to the first terminal device and the voice output based on the voice data of the input voice received by the second terminal device from the first terminal device based on a comparison between the voice recognition result by the first terminal device and the voice recognition result by the second terminal device.

### CROSS-REFERENCE TO RELATED APPLICATION

This application is based upon and claims the benefit of priority from Japanese Patent Application No. 2021-005857, filed on Jan. 18, 2021, the entire contents of which are incorporated herein by reference.

### FIELD

Embodiments described herein relate generally to a server, a terminal device, and a method for online conferencing.

### BACKGROUND

In the related art, there is a technique called online conferencing in which a plurality of terminal devices connected via a network transmit and receive voices to perform a dialogue between a plurality of persons. In many cases, a plurality of terminal devices participating in the online conferencing are in different communication environments. In a terminal device with a poor communication environment, a portion of the voice input by the other terminal device may be interrupted or may not be output as an accurate voice.

In the related art, as one technique for measuring a communication quality between terminal devices in the online conferencing, there is a technique in which a small amount of test data is reciprocated and a throughput (transfer speed) is obtained from a time difference. Although such techniques in the related art are simple, these techniques often do not reflect human experience in the online conferencing. For example, in some cases, a voice may be heard even if the throughput is temporarily low, or the voice maybe interrupted even if the measured value of the throughput is stable. For this reason, there is a demand for a device that can reliably detect whether the voice of the talker is accurately reaching an audience during the online conferencing.

### DESCRIPTION OF THE DRAWINGS

FIG. 1 is a diagram schematically illustrating a configuration example of an online conferencing system according to at least one embodiment;

FIG. 2 is a block diagram illustrating a configuration example of a control system in a server;

FIG. 3 is a block diagram illustrating a configuration example of the control system in terminal devices;

FIG. 4 is a diagram illustrating an example of voice recognition results by a plurality of the terminal devices;

FIG. 5 is a flowchart illustrating an operation example of the server; and

FIG. 6 is a flowchart illustrating an operation example of the server.

### DETAILED DESCRIPTION

In order to solve the above-mentioned problems, a server, a terminal device, and a method for online conferencing that can confirm that a voice of a talker is not normally output by a terminal device on a reception side are provided.

According to at least one embodiment, a server includes a communication interface, a memory, and a processor. The communication interface communicates with a first terminal device that transmits voice data generated from an input voice and a second terminal device that outputs a voice based on the voice data received from the first terminal device. The memory stores a voice recognition result by the first terminal device for an input voice input to the first terminal device and a voice recognition result by the second terminal device for the voice data of the input voice received by the second terminal device from the first terminal device. The processor determines a difference between the input voice input to the first terminal device and the voice output based on the voice data of the input voice received by the second terminal device from the first terminal device, based on a comparison between the voice recognition result by the first terminal device and the voice recognition result by the second terminal device.

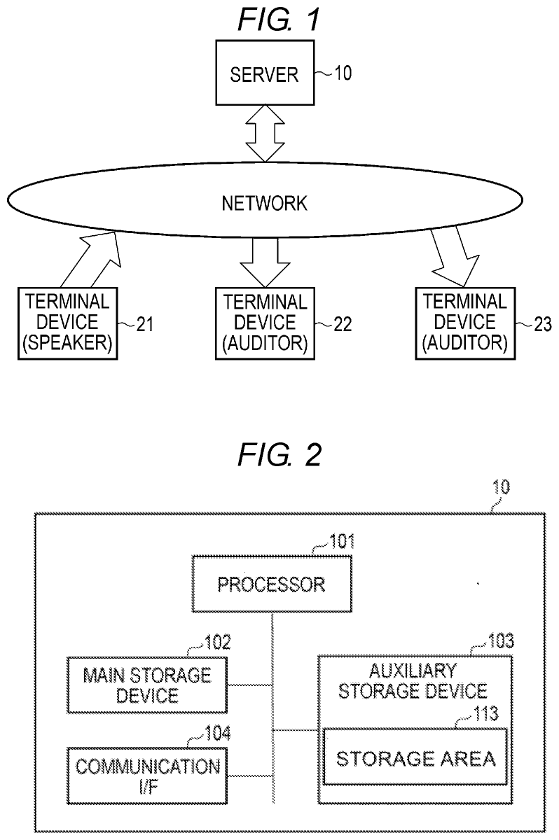

Hereinafter, at least one embodiment is described with reference to the drawings. FIG. 1 is a diagram for schematically explaining an online conferencing system 1 according to at least one embodiment. As illustrated in FIG. 1, the online conferencing system 1 according to the embodiment has a server 10 and a plurality of terminal devices 20 (21, 22, 23, or . . . ) which are connected via a network. The server 10 is a management device that manages a quality of voice calls in each terminal device 20. The server 10 determines how the voice input to a certain terminal device (first terminal device) 21 is output by the other terminal devices (second terminal devices) 22 and 23 which are connected via the network. In the example illustrated in FIG. 1, the first terminal device is the terminal device 21 for inputting the voice by the talker, and the second terminal devices are the terminal devices 22 and 23 of audience other than the talker.

The server 10 acquires a voice recognition result of the voice input to the terminal device (first terminal device) 21 by the talker from the terminal device 21. In addition, the server 10 acquires the voice recognition result for the voice (voice output by the second terminal device) received from the terminal device 21 by the terminal devices (second terminal device) 22 and 23 other than the talker (audience) via the network, from the terminal devices 22 and 23.

The server 10 compares the voice recognition result of the voice input to terminal device 21 of the talker with the voice recognition result of the voice output by the terminal devices 22 and 23 of the audience. When the voice recognition result of the terminal device 21 and the voice recognition result of the terminal devices 22 and 23 match each other, the server 10 determines that the voice input to the terminal device 21 is accurately output by the terminal devices 22 and 23. If the voice recognition results of the terminal devices 22 and 23 and the voice recognition result of the terminal device 21 are different from each other, the server 10 determines that the voice input to the terminal device 21 is not accurately output by the terminal devices 22 and 23. The server 10 transmits a warning to the terminal devices 22 and 23 if the voice recognition results of the terminal devices 22 and 23 and the voice recognition results of the terminal device 21 are different from each other by exceeding a default value (threshold value).

The plurality of terminal devices 20 (21, 22, 23, . . . ) are information processing devices including a microphone and a speaker. The microphone inputs (collects) sounds including sounds uttered by a person. The speaker outputs a sound based on voice data. The information processing device as the terminal device 20 may be, for example, a personal computer, a smartphone, a tablet terminal, or the like. In addition, the terminal device 20 may have a configuration in which any one or both of a microphone 206 and a speaker 207 are connected to an information processing device such as a computer.

The terminal device 20 collects the sound (voice) uttered by the talker with the microphone and transmits the data (voice data) of the collected voice to the other terminal device 20 participating in the online conferencing. In addition, the terminal device 20 receives the voice data of the voice and the like of the talker received from the other terminal device 20 via the network and outputs the received voice data as the sound from the speaker.

The terminal device 20 transmits the voice data of the sound collected with the microphone to the other terminal device and outputs the sound based on the voice data received from the other terminal device by the speaker. In addition, the terminal device 20 performs the voice recognition processing. If the voice of the talker is collected with the microphone 206, the terminal device 20 performs the voice recognition processing on the collected voice. In addition, when receiving the voice data from the other terminal device, the terminal device 20 performs the voice recognition processing on the voice to be output based on the received voice data. Furthermore, the terminal device 20 uploads the voice recognition result by the voice recognition processing to the server 10.

FIG. 1 schematically illustrates an example in which the terminal device 21 is the first terminal device used by the talker and the terminal devices 22 and 23 are the second terminal devices used by the audience. In the example illustrated in FIG. 1, the terminal device 21 as the first terminal device collects the sound uttered by the talker with the microphone and transmits the data (voice data) of the voice collected to the other terminal devices 22 and 23. The terminal devices 22 and 23 as the second terminal devices receive the voice data from the terminal device 21 via the network and output the sound based on the received voice data from the speaker.

In addition, when detecting the sound uttered by the talker from the sound collected with the microphone 206, the terminal device 21 as the first terminal device performs the voice recognition processing on the voice collected with the microphone 206. The terminal device 21 transmits the voice recognition result by the voice recognition processing for the voice collected with the microphone 206 to the server 10. In addition, when receiving the voice data from the terminal device 21 as the first terminal device, the terminal devices 22 and 23 as the second terminal devices perform the voice recognition processing for the sound based on the received voice data. The terminal devices 22 and 23 transmit the voice recognition result by the voice recognition processing for the sound based on the voice data received from the terminal device 21 to the server 10.

Next, the configuration of the server 10 according to the embodiment will be described. FIG. 2 is a block diagram illustrating a configuration example of the server 10 according to at least one embodiment. As illustrated in FIG. 2, the server 10 includes a processor 101, a main storage device 102, an auxiliary storage device (memory) 103, and a communication interface 104. The processor 101 controls the entire server 10. The processor 101 is, for example, a CPU. The processor 101 performs various processes described later by executing the program. For example, the processor 101 performs processing such as comparison of the voice recognition results by the respective terminal devices and outputting of a warning according to the comparison result of the voice recognition results.

The main storage device 102 is a main memory for storing data. The main storage device 102 is configured with, for example, a random access memory (RAM) or the like. The main storage device 102 temporarily stores the data being processed by the processor 101. For example, the main storage device 102 stores the data necessary for executing the program, the execution result of the program, and the like. The main storage device 102 also operates as a buffer memory for temporarily retaining the data.

The auxiliary storage device 103 is a storage for storing data. The auxiliary storage device 103 includes a non-rewritable non-volatile memory such as a read only memory (ROM), a rewritable non-volatile memory, and the like. The rewritable non-volatile memory is configured with, for example, a hard disk drive (HDD), a solid state drive (SSD), an EEPROM (registered trademark), a flash ROM, or the like.

The auxiliary storage device 103 stores various programs and control data executed by the processor 101, and the like. For example, the auxiliary storage device 103 stores a program for comparing the voice recognition results by the respective terminal devices 20 in the online conferencing system. In addition, the auxiliary storage device 103 stores a program for outputting a warning according to the comparison result of the voice recognition results by the respective terminal devices 20.

In addition, in at least one embodiment, as illustrated in FIG. 2, the auxiliary storage device 103 has a storage area 113 for storing the voice recognition results by the respective terminal devices 20. The storage area 113 stores the voice recognition result for the voice input to the terminal device 21 and the voice recognition result for the voice received (output) from the terminal device 21 by the terminal devices 22 and 23.

The communication interface 104 is an interface for communicating with each terminal device 20 in the online conferencing system. The communication interface may include an interface that communicates through a wired line or may include an interface that communicates wirelessly. For example, the processor 101 acquires the voice recognition result from each terminal device 20 participating in the online conferencing system via the communication interface 104. In addition, the processor 101 transmits the warning according to the comparison result of the voice recognition results by the respective terminal devices 20 to the specific terminal device 20 via the communication interface 104.

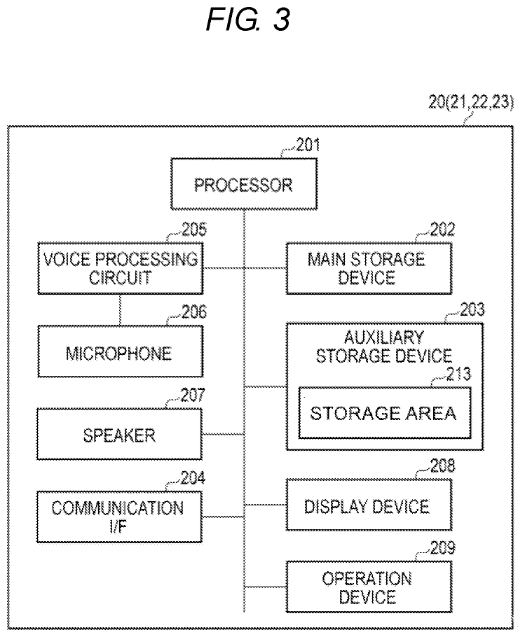

Next, the configuration of the terminal device 20 according to at least one embodiment will be described. FIG. 3 is a block diagram illustrating the configuration example of the terminal device 20 according to at least one embodiment. In the configuration example illustrated in FIG. 3, the terminal device 20 includes a processor 201, a main storage device 202, an auxiliary storage device (memory) 203, a communication interface 204, a voice processing circuit 205, the microphone 206, the speaker 207, a display device (notification device) 208, an operation device 209, and the like.

The processor 201 controls the entire terminal device 20. The processor 201 is, for example, a CPU. The processor 201 performs various processes described later by executing the program. For example, the processor 201 performs processing such as generation of the voice data of the input sound, transmission of the voice data, voice recognition for the input sound, transmission of the voice recognition result to server 10, outputting of the warning, and the like. In addition, the processor 201 performs reception of the voice data, outputting of the voice based on the voice data, recognition of the voice for the voice to be received (output), transmission of the voice recognition result to the server 10, and the like.

The main storage device 202 is a main memory for storing data. The main storage device 202 is configured with, for example, a random access memory (RAM) or the like. The main storage device 202 temporarily stores the data being processed by the processor 201. For example, the main storage device 202 may store the data necessary for executing the program, the execution result of the program, and the like. The main storage device 202 also operates as a buffer memory for temporarily retaining the data. For example, the main storage device 202 retains the voice data obtained by processing the sound collected with each microphone 206 by the voice processing circuit 205. In addition, the main storage device 202 retains the received voice data.

The auxiliary storage device 203 is a storage for storing data. The auxiliary storage device 203 includes a non-rewritable non-volatile memory such as a read-only memory (ROM), a rewritable non-volatile memory, and the like. The rewritable non-volatile memory is configured with, for example, a hard disk drive (HDD), a solid state drive (SSD), an EEPROM (registered trademark), a flash ROM, or the like.

The auxiliary storage device 203 stores programs executed by the processor 201, control data, and the like. The auxiliary storage device 203 stores the programs for performing various processes as described above. For example, the auxiliary storage device 203 stores the voice recognition program for performing the voice recognition for the input voice or the received voice data. In addition, the auxiliary storage device 203 stores the program for transmitting the voice recognition result to the server 10, the program for outputting the warning in response to the notification from the server 10, and the like. Furthermore, in the example illustrated in FIG. 3, the auxiliary storage device 203 has a storage area 213 for retaining the voice recognition result.

The communication interface 204 is an interface for communicating with the other terminal devices 20 and server 10 participating in the online conferencing system. The communication interface 204 may include an interface that communicates through a wired line or may include an interface that communicates wirelessly. For example, the processor 201 performs transmission and reception of the voice data to and from the other terminal device 20 participating in the online conferencing system via the communication interface 204. In addition, the processor 201 transmits the voice recognition result for the input voice or the received voice data to the server 10. Furthermore, when receiving a warning notification via the communication interface 204, the processor 201 performs the processing of notifying the warning by using the speaker, the display device, or the like.

The microphone 206 collects (acquires) sound. For example, the microphone 206 inputs the collected sound as an analog signal (analog waveform) and outputs the analog signal of the input sound to the voice processing circuit 205. The voice processing circuit 205 inputs an analog signal of the sound collected with the microphone 206, and outputs the voice data as digital data obtained by digitalizing the analog signal of the input sound. The voice processing circuit 205 includes an AD converter or the like that digitizes analog waveforms. It is noted that the microphone 206 may be an external device connected to the terminal device 20. If the microphone 206 is configured as an external device, the voice processing circuit 205 may be provided with an interface for voice input to connect the microphone 206.

The speaker 207 outputs the voice. The speaker 207 utters a sound based on the response waveform as the response voice supplied from the processor 201. In addition, the speaker 207 may output the warning content according to the warning received from the server 10 described later as the notification device by the voice. It is noted that the speaker 207 may be an external device connected to the terminal device 20. If the speaker 207 is configured as an external device, the terminal device 20 may be provided with an interface that outputs a signal indicating the sound waveform to be output to the speaker 207.

The display device 208 displays an image. The display device 208 operates as the notification device. For example, the display device 208 displays a warning screen for notifying a warning in response to the warning received from the server 10 described later. The operation device 209 receives an operation instruction from the user. For example, the display device 208 and the operation device 209 may be configured by a display with a touch panel. In addition, the operation device 209 may include a numeric keypad, a keyboard, a pointing device, or the like.

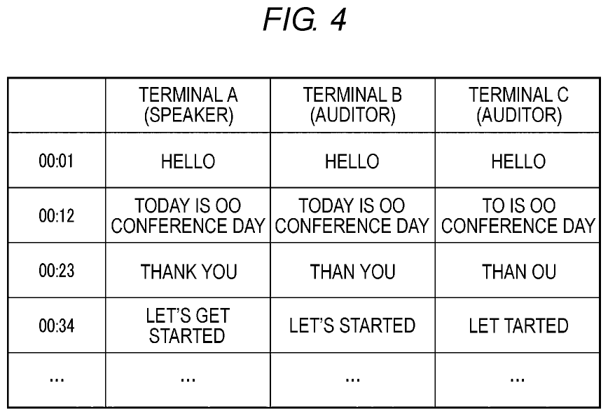

Next, the voice recognition result collected by the server 10 according to at least one embodiment from each terminal device 20 will be described. FIG. 4 is a diagram illustrating an example of the voice recognition result by each terminal device 20 stored in the storage area 113 of the auxiliary storage device 103 in the server 10. The server 10 collects the voice recognition results by the respective terminal devices 20. The server 10 stores the voice recognition results collected from the respective terminal devices in the storage area 113 of the auxiliary storage device 103. In the example illustrated in FIG. 4, the server 10 stores the voice recognition result for the voice data of the input voice received by the other terminal device in association with the voice recognition result for the input voice. In the example illustrated in FIG. 4, the terminal device (first terminal device) 21 of the talker is the terminal A, and the terminal devices (second terminal devices) 22 and 23 of the audience are the terminals B and C.

The terminal A inputs the voice uttered by the talker with the microphone 206 and performs the voice recognition for the voice (input voice) that is input. The terminal A supplies the voice recognition result for the input voice to the server 10 in association with the information (time information) indicating the time. Herein, the terminal A may transmit, together with the voice recognition result and the time information, the information indicating the voice recognition result for the voice (input voice) uttered by the talker.

In addition, each of the terminal B and the terminal C receives the voice data of the input voice from the terminal A and performs the voice recognition on the received voice data. The terminal B and the terminal C supply the voice recognition result for the received voice data to the server 10 in association with the time information. Herein, the terminal B and the terminal C may transmit, together with the voice recognition result and the time information, the information indicating the voice recognition result for the voice data received via the network. In addition, the terminal B and the terminal C may transmit, together with the voice recognition result and the time information, the information indicating the voice recognition result for the voice data from the terminal A.

The server 10 stores the voice recognition results on the terminals A, B, and C in association with the time information. It is assumed that the difference between the time when the terminal A inputs the input voice and the time when the other terminals B and C receive the voice data of the input voice of the terminal A is short. In this case, as illustrated in FIG. 4, the voice recognition result for the input voice and the voice recognition results for the voice data of the input voice received by the other terminals are stored in association with each other in the storage area 113.

The difference between the voice recognition result for the input voice by the terminal A of the talker and the voice recognition result for the voice data of the input voice by the terminal B indicates the communication quality between the terminal A and the terminal B. The voice recognition result for the input voice by the terminal A of the talker is not affected by the communication environment of the network or the like. On the other hand, the voice recognition result for the voice data of the input voice by the terminals B and C of the audience is affected by the communication environment (communication quality) with the terminal A. For example, if the communication quality between the terminal B and the terminal A is poor, the voice recognition result by the terminal B is significantly different from the voice recognition result by the terminal A.

That is, if the difference between the voice recognition result for the input voice by the terminal A and the voice recognition result for the voice data of the input voice by the terminal B becomes large, it can be determined that the communication status between the terminal A and the terminal B is deteriorated. If the voice recognition result for the input voice by the terminal A and the voice recognition result for the voice data of the input voice by the terminal B match each other, it can be determined that the communication status between the terminal A and the terminal B is good. Similarly, the communication status between the terminal A and the terminal C can be determined by the difference between the voice recognition result for the input voice by the terminal A and the voice recognition result for the voice data of the input voice by the terminal C.

In the example illustrated in FIG. 4, the voice recognition result for the input voice input to the terminal A at the time “00:01” matches the voice recognition results corresponding to the input voice in the terminals B and C. The voice recognition result for the input voice at the time “00:12” matches the voice recognition result corresponding to the input voice in the terminal B. However, the voice recognition result for the input voice at the time “00:12” partially does not match the voice recognition result corresponding to the input voice in the terminal C. As a result, at the time “00:12”, it can be determined that the communication quality between the terminal A and the terminal B is good, but the communication quality between the terminal A and the terminal C is slightly deteriorated.

In addition, in the example illustrated in FIG. 4, the voice recognition result for the input voice at the time “00:23” does not match the voice recognition results corresponding to the input voice in the terminals B and C. In addition, the voice recognition result for the input voice at the time “00:34” does not match the voice recognition result corresponding to the input voice in the terminals B and C. As a result, at the times “00:23” and “00:34”, it can be determined that, since the communication quality of the terminal B and the terminal C with the terminal A is poor, the input voice cannot be normally output.

In at least one embodiment, the server 10 acquires the information as illustrated in FIG. 4 by collecting the voice recognition result from each terminal device participating in the online conferencing. The server 10 compares the voice recognition result for the input voice with the voice recognition result for the voice data of the input voice received by the other terminal device. The server 10 determines the difference between the input voice of the terminal A and the output voice of the terminal B or C corresponding to the input voice by calculating the difference of the corresponding voice recognition results.

The server 10 determines whether or not the magnitude of the difference between the voice recognition result by the terminal A and the voice recognition result by the terminal B or the terminal C exceeds a predetermined threshold value (default value). If the magnitude of the difference exceeds the predetermined threshold value, the server 10 warns the terminal A that the voice is not output normally. For example, if the difference between the voice recognition result by the terminal A and the voice recognition result by the terminal B exceeds the threshold value, the server 10 warns the terminal

A that the voice of the talker cannot be normally output by the terminal B. The terminal A notifies the warning from the server 10 by the display device 208. As a result, the talker using the terminal A can know which terminal the sound is not normally output from.

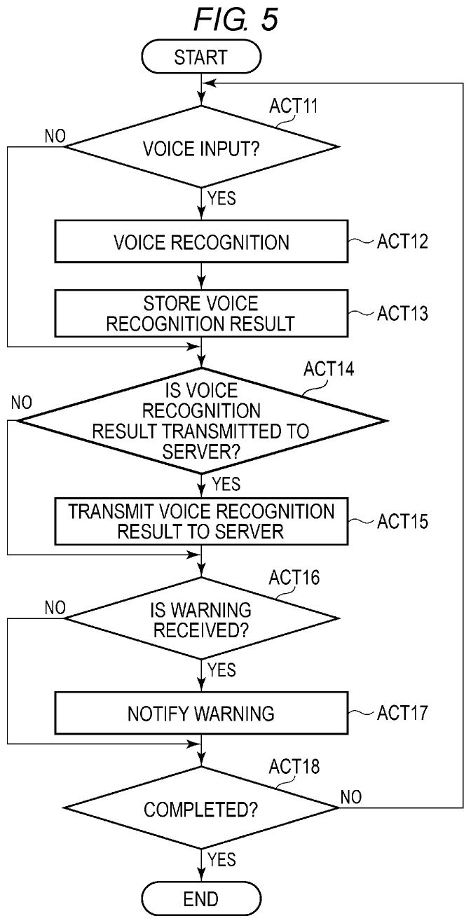

Next, the operation of the terminal device 20 in the online conferencing system 1 according to at least one embodiment will be described. FIG. 5 is a flowchart for explaining an operation example of the terminal device 20 in the online conferencing system 1 according to at least one embodiment. The processor 201 of the terminal device 20 participating in the online conferencing system receives the input of the voice collected with the microphone 206 or the input of the voice (voice data) received from the other terminal device 20 (ACT11). The processor 201 may switch between an operation mode in which the voice input from the microphone 206 is enabled and an operation mode in which the voice input from the microphone 206 is disabled. For example, the processor 201 enables or disables the voice input from the microphone 206 in response to an instruction input by the user by using the operation device 209.

If the voice input from the microphone 206 is disabled, the processor 201 performs inputting (reception) of the voice data from the other terminal device 20 without acquiring the input voice (YES inACT11). When receiving the voice data from the other terminal device 20, the processor 201 outputs the voice based on the voice data from the speaker 207. As a result, the terminal devices 20 (terminal device 21 as the first terminal device)output the input voice input by the other terminal device 20 (terminal devices 22 and 23 as the second terminal devices) from the speaker 207.

If the voice input from the microphone 206 is enabled, the processor 201 acquires the sound collected with the microphone 206 as the input voice via the voice processing circuit 205 (ACT11, YES). The processor 201 transmits (delivers) voice data generated from the acquired input voice to the other terminal device 20. As a result, the processor 201 of the terminal device 20 (for example, the terminal device 21 as the first terminal device) can transmit (deliver) the sound (input voice) collected with the microphone 206 and uttered by the talker to the other terminal devices 20 (for example, the terminal devices 22 and 23 as the second terminal devices) as the voice data. If the voice input from the microphone 206 is enabled, the processor 201 performs the processing of outputting the voice based on the voice data received from the other terminal device 20 from the speaker 207 in parallel with the processing of delivering the input voice to the other terminal device 20.

If the input voice collected with the microphone 206 is acquired via the voice processing circuit 205 (YES in ACT11), the processor 201 performs the voice recognition processing on the input voice (ACT12). The processor 201 stores the voice recognition result for the input voice in the storage area 213 of the auxiliary storage device 203 (ACT13). For example, the processor 201 stores the voice recognition result in the storage area 213 in association with the time information indicating the time if the input voice is input. Furthermore, the processor 201 also stores information indicating that the voice recognition result is the voice recognition result for the input voice collected with the microphone 206.

In addition, if the voice data from the other terminal device 20 is received by the communication I/F 204 (YES in ACT11), the processor 201 performs the voice recognition processing on the received voice data (ACT12). The processor 201 stores the voice recognition result for the voice data received from the other terminal device 20 in the storage area 213 of the auxiliary storage device 203 (ACT13). For example, the processor 201 stores the voice recognition result in the storage area 213 in association with the time information indicating the time when the voice data is input. Furthermore, the processor 201 also stores the information indicating that the voice recognition result is the voice recognition result for voice data received from the other terminal device.

Herein, it is assumed that the voice recognition processing for the input voice and the voice recognition processing for the received voice data are executed by the same program for the voice recognition. In addition, the voice recognition processing performed by each terminal device 20 is assumed to be executed by the program for the voice recognition configured with an equivalent algorithm. However, the programs for the voice recognition executed by the respective terminal devices 20 may be different programs as long as the recognition results for the same voice do not differ by a threshold value or more.

In addition, the processor 201 determines whether or not to transmit the voice recognition result stored in the storage area 213 to the server 10 (ACT14). The processor 201 transmits the voice recognition result stored in the storage area 213 to the server 10 based on the preset conditions. For example, the processor 201 transmits the voice recognition result at each predetermined time interval. In addition, the processor 201 may transmit the voice recognition result to the server 10 every time a series of sentences are stored as the voice recognition result. In addition, the processor 201 may transmit the voice recognition result to the server 10 every time the amount of data of the non-transmitted voice recognition result stored in the storage area 213 reaches a predetermined amount.

If it is determined that the voice recognition result is transmitted to the server 10, the processor 201 transmits the non-transmitted voice recognition result stored in the storage area 213 to the server 10 by the communication I/F 204 (ACT15). For example, the processor 201 transmits the voice recognition result in which additional information such as time information is associated with each series of sentences (texts) obtained by the voice recognition to the server 10.

In addition, the processor 201 receives a warning from the server 10 during the online conferencing (ACT16). When receiving the notification indicating the warning from the server 10, the processor 201 notifies the warning according to the notified content (ACT17). For example, it is assumed that, after the terminal A delivers the input voice (remark of the talker) input to the microphone 206 to the terminal B, the terminal B receives a warning indicating that the input voice is not normally output from the server 10. In this case, the processor 201 of the terminal A displays a warning indicating that the input voice (remark of the talker) is not normally output by the terminal B on the display device 208.

Accordingly, the terminal device (first terminal device) of the talker can notify the terminal device (second terminal device) in which the remark of the talker is not normally output. As a result, the talker using the first terminal device can recognize the terminal device in which the talker's own remark is not normally output without interrupting the online conferencing.

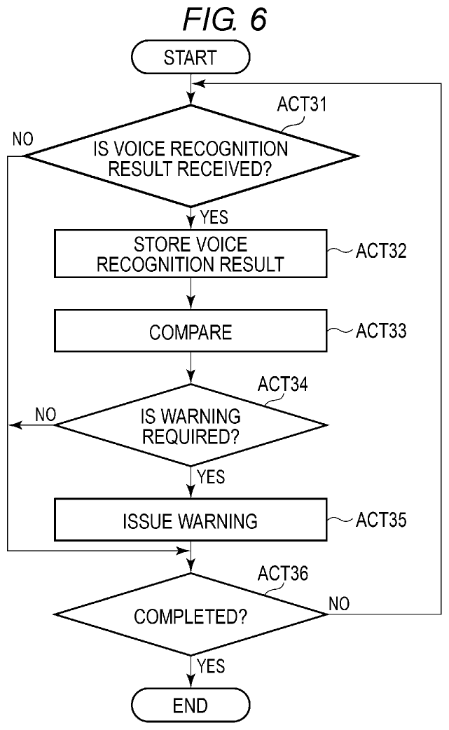

Next, the operation of the server 10 in the online conferencing system 1 according to at least one embodiment will be described. FIG. 6 is a flowchart for explaining an operation example of the server 10 in the online conferencing system 1 according to at least one embodiment. The processor 101 of the server 10 communicates with each terminal device 20 participating in the online conferencing by the online conferencing system 1. The processor 101 receives the voice recognition result from each terminal device 20 by the communication I/F 104 (ACT31).

If the voice recognition result is received from a certain terminal device 20 (YES in ACT31), the processor 101 stores the received voice recognition result in the auxiliary storage device 103 (ACT32). For example, the processor 101 stores the voice recognition result received from each terminal device 20 in the storage area 113 of the auxiliary storage device 103 in association with each time. In addition, as illustrated in FIG. 4, the processor 101 may store the voice recognition result (voice recognition result for voice data of input voice received via the network) by the terminal device (second terminal device) of the audience in the storage area 113 in association with the voice recognition result (voice recognition result for the input voice) by the terminal device (first terminal device) 20 of the talker.

If the voice recognition result received from the terminal device 20 is stored, the processor 101 compares the stored voice recognition result (ACT33). The processor 101 allows the voice recognition result for the input voice input by the terminal device 20 of the talker to be associated with the voice recognition result for the voice data of the input voice received by the terminal device 20 of the audience. The processor 101 calculates the difference between the voice recognition result for the input voice and the voice recognition result for the voice data received by the other terminal device 20. For example, the processor 101 quantifies the difference between the two corresponding voice recognition results by using a Levenshtein distance.

Herein, it is assumed that the voice recognition programs used by the processors 201 of the respective terminal devices 20 for the voice recognition are the same. If the voice data of the input voice output from a certain terminal device (first terminal device) is accurately transmitted to the other terminal device (second terminal device), the input voice and the output voice based on the voice data of the input voice match each other. In this case, the voice recognition result for the input voice by the first terminal device and the voice recognition result for the voice data of the input voice by the second terminal device also match each other. On the other hand, if the voice data of the input voice output from the first terminal device is not accurately transmitted to the second terminal device, the input voice and the output voice based on the voice data of the input voice do not match each other. In this case, the voice recognition result for the input voice by the first terminal device and the voice recognition result for the voice data of the input voice by the second terminal device do not match each other.

The input voice input to the first terminal device is converted into a text by the voice recognition result for the input voice by the first terminal device. The output voice based on the voice data of the input voice received by the second terminal device from the first terminal device is converted into a text by the voice recognition result for the voice data (output voice) of the input voice received by the second terminal device. Therefore, the difference between the voice recognition result by the first terminal device and the voice recognition result by the second terminal device has a value indicating the degree to which the input voice input by the first terminal device is accurately output by the second terminal device. For example, the more unstable the communication path from the first terminal device to the second terminal device, the greater the difference between the voice recognition result by the first terminal device and the voice recognition result by the second terminal device.

The processor 101 determines whether or not to issue a warning based on the difference between the voice recognition result for the input voice (voice recognition result by the first terminal device) and the voice recognition result for the voice data received by the other terminal device 20 (voice recognition result by the second terminal device) (ACT34). For example, the processor 101 determines whether or not the difference between the voice recognition result for the input voice and the voice recognition result for the voice data (output voice) received by the other terminal device 20 exceeds a predetermined threshold value. The predetermined threshold value is set to a level at which the user can recognize that the input voice and the output voice have the same content.

If the difference between the voice recognition result for the input voice and the voice recognition result for the output voice exceeds the predetermined threshold value, the processor 101 determines that a warning is issued. If the difference between the voice recognition result for the input voice and the voice recognition result for the output voice is equal to or less than the predetermined threshold value, the processor 101 determines that it is not necessary to issue a warning.

The processor 101 may compare the difference between the voice recognition result by the first terminal device and the voice recognition result by the second terminal device with a plurality of threshold values. For example, as the plurality of threshold values, a first threshold value and a second threshold value smaller than the first threshold value may be set. The processor 101 may issue a first warning if the difference exceeds the first threshold value, and the processor 101 may issue a second warning if the difference is equal to or less than the first threshold value and exceeds the second threshold value. As a result, the server 10 can issue a warning according to the difference between the voice recognition result by the first terminal device and the voice recognition result by the second terminal device.

In addition, the processor 101 may store the difference between the voice recognition result by the first terminal device and the voice recognition result by the second terminal device in the time series. In this case, the processor 101 may issue a warning according to the change in time series of the difference between the voice recognition result by the first terminal device and the voice recognition result by the second terminal device. For example, the processor 101 may issue a warning if the difference between the voice recognition result by the first terminal device and the voice recognition result by the second terminal device tends to be large.

If it is determined that a warning is necessary (YES in ACT34), the processor 101 notifies the terminal device (first terminal device) 20 to which the input voice is input of the warning (ACT35). The processor 101 specifies the terminal device 20 that executes the voice recognition for the input voice as the first terminal device. For example, the processor 101 specifies the terminal device 20 that is the transmission source of the voice recognition result for the input voice as the first terminal device. If the terminal device (first terminal device) to which the input voice is input is specified, the processor 101 transmits a warning indicating that the input voice is not normally transmitted to the first terminal device that is the transmission source of the input voice by the other terminal device.

In addition, the processor 101 may specify the second terminal device that is the transmission source of the voice recognition result of the output voice of which difference from the voice recognition result for the input voice exceeds the threshold value. If the second terminal device is specified, the processor 101 transmits a warning indicating that the input voice is not normally transmitted to the specified second terminal device to the first terminal device that is the transmission source of the input voice.

The processor 101 may notify a plurality of terminal devices or a preset terminal device of the warning without specifying the terminal device (first terminal device) 20 to which the input voice is input. For example, the processor 101 may notify the warning to all the terminal devices (or all the terminal devices that transmit the voice recognition result) 20 participating in the online conferencing. In addition, the processor 101 may notify the warning to a preset terminal device such as a terminal device used by an organizer.

The processor 101 of the server 10 repeatedly performs the processing of ACT31 to ACT35 as described above while the online conferencing continues (NO in ACT36). In addition, when receiving an instruction to stop the processing of notifying the talker of the warning, the processor 101 may end the processing of ACT31 to ACT35.

The processing of the server 10 described above may be performed by any terminal device 20. That is, the online conferencing system 1 may be configured by causing any one of the terminal devices 20 to perform the processing of the server 10 described above. For example, the terminal device 20 can perform the above-mentioned processing by installing a program that performs the above-mentioned processing of the server 10. Accordingly, it is possible to configure the online conferencing system including a plurality of the terminal devices 20 without providing the server 10.

According to the above-described processing, the server of the online conferencing system according to the embodiment acquires the voice recognition result for the input voice from the first terminal device. The server acquires the voice recognition result for the voice data of the input voice received by the second terminal device from the first terminal device from the second terminal device. The server determines the difference between the voice recognition result for the input voice acquired from the first terminal device and the voice recognition result for the voice data of the input voice acquired from the second terminal device.

Therefore, the server according to the embodiment can evaluate whether or not the input voice input by the first terminal device is normally output by the second terminal device. As a result, it is possible to evaluate the communication status between the first terminal device and the second terminal device.

In addition, the server issues a warning if the difference between the voice recognition result for the input voice and the voice recognition result for the voice data of the input voice received by the second terminal device exceeds the threshold value. Accordingly, it is possible to notify that the input voice input by the first terminal device is not normally output by the second terminal device.

Furthermore, if the difference between the voice recognition result for the input voice and the voice recognition result for the voice data of the input voice received by the second terminal device exceeds the threshold value, the server issues a warning to the first terminal device. Accordingly, it is possible to notify the talker who is the user of the first terminal device that the input voice input by the first terminal device is not normally output by the second terminal device. As a result, the talker can recognize during the online conferencing that the talker's own remark is not output normally by the terminal device of the audience.

In the above-described embodiment, the case where the program executed by the processor is stored in the memory in the device has been described. However, the program executed by the processor may be downloaded from the network to the device or may be installed from the storage medium to the device. The storage medium may be a storage medium such as a CD-ROM that can store a program and can be read by the device. In addition, the functions obtained by installation or downloading in advance may be realized in cooperation with the operating system (OS) or the like inside the device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A server comprising:
a communication interface configured to communicate with a first terminal device configured to transmit voice data generated from an input voice and to communicate with a second terminal device configured to output a voice based on the voice data received from the first terminal device;
a memory configured to store a voice recognition result by the first terminal device for an input voice input to the first terminal device and to store a voice recognition result by the second terminal device for the voice data of the input voice received by the second terminal device from the first terminal device; and
a processor configured to determine a difference between (i) the input voice input to the first terminal device and (ii) the voice output based on the voice data of the input voice received by the second terminal device from the first terminal device, based on a comparison between the voice recognition result by the first terminal device and the voice recognition result by the second terminal device.

2. The server according to claim 1, wherein
the processor is configured to output a warning indicating that (i) the input voice input to the first terminal device and (ii) the voice output based on the voice data of the input voice received by the second terminal device from the first terminal device, do not match each other, in response to determining that the difference between the voice recognition result by the first terminal device and the voice recognition result by the second terminal device exceeds a threshold value.

3. The server according to claim 1, wherein
the processor is configured to transmit a warning indicating that the input voice is not normally output by the second terminal device to the first terminal device, when the difference between the voice recognition result by the first terminal device and the voice recognition result by the second terminal device exceeds a threshold value.

4. The server according to claim 1, wherein the second terminal device includes a plurality of terminals, each of the plurality of terminals configured to output voice data based on the voice data received from the first terminal device.

5. The server according to claim 1, wherein each of the terminal devices includes a microphone configured to collect sound including voice data.

6. The server according to claim 1, wherein each of the terminal devices includes a speaker configured to output voice data.

7. The server according to claim 1, wherein the processor is configured to determine the difference based on a Levenshtein distance.

8. The server according to claim 1, wherein the processor is configured to determine the difference based on voice data converted to text.

9. The server according to claim 1, further including a display device, wherein the processor is configured to cause the display device to display a warning.

10. A terminal device comprising:
a communication interface configured to communicate with a server and another terminal device; and
a processor configured to:
transmit voice data of an input voice collected with a microphone to the another terminal device, and transmit a voice recognition result for the input voice to the server;
output a voice based on the voice data received from the another terminal device via the communication interface from a speaker, and transmit the voice recognition result for the voice data to the server; and
notify a warning using a notification device, when a notification indicating that (i) the input voice from the server and (ii) the voice output based on the voice data of the input voice received by the another terminal device, do not match each other.

11. The device according to claim 10, further comprising:
a memory configured to store the voice recognition result, wherein
the processor is configured to:
store the voice recognition result for the input voice and the voice recognition result for the voice data in the memory, and
transmit the voice recognition result stored in the memory to the server every time the voice recognition result reaches a default value.

12. A method for online conferencing including causing a server that includes a communication interface that communicates with a plurality of terminal devices participating in the online conferencing to execute operations comprising:
storing a voice recognition result by a first terminal device for an input voice received from the first terminal device that transmits a voice data generated from the input voice to another terminal device via the communication interface in a memory;
storing a voice recognition result by a second terminal device for a voice data of the input voice received from the second terminal device that outputs a voice based on the voice data received from the first terminal device via the communication interface in the memory; and
determining a difference between (i)the input voice input to the first terminal device and (ii) the voice output based on the voice data of the input voice received by the second terminal device from the first terminal device, based on a comparison between the voice recognition result by the first terminal device and the voice recognition result by the second terminal device.

13. The method according to claim 12, wherein the second terminal device includes a plurality of terminals, each of the plurality of terminals configured to output voice data based on the voice data received from the first terminal device.

14. The method according to claim 12, wherein each of the terminal devices includes a microphone configured to collect sound including voice data.

15. The method according to claim 12, wherein each of the terminal devices includes a speaker configured to output voice data.

16. The method according to claim 12, wherein determining the difference comprises determining a Levenshtein distance.

17. The method according to claim 12, wherein the determining the difference is based on voice data converted to text.

18. The method according to claim 12, further comprising displaying, on a display device, a warning during the online conferencing.
